(19) United States
(12) Patent Application Publication
(10) Pub. No.: US 2006/0106806 A1
(43) Pub. Date: May 18, 2006

(54) Software update for a plurality of mobile devices

(75) Inventors: David P. Sperling, Laguna Niguel, CA (US); Murtaza A. Ghulamali, Mission Viejo, CA (US)

Correspondence Address: CROWELL & MORING LLP;INTELLECTUAL PROPERTY GROUP, P.O. BOX 14300, WASHINGTON, DC, 20044-4300, US

(73) Assignee: Smith Micro Software, Inc.

(21) Appl. No.: 10/986,753

(22) Filed: Nov. 12, 2004

(51) Int. Cl. G06F 17/30; G06F 7/00

(52) U.S. Cl. 707/10

(57) ABSTRACT

A system and method for providing software updates to a plurality of mobile devices includes a central update server and update software resident on each mobile device. The update server includes a database of software program identifiers and identifiers for corresponding updates, a subset of which may not be compatible with each mobile device. The mobile device initiates the update process by preparing a request in accordance with configuration information and security/privacy settings, and communicating the request to the update server to retrieve corresponding update information. Due to security/privacy settings, the request may be insufficient for the update server to identify relevant software updates. The mobile device selects at least one of the software updates, and communicates with the update server to download the selected updates. The retrieved update information may also include a referral to another update server, and the mobile device will repeat the update process with the referral server.

### BACKGROUND OF THE INVENTION

The present invention relates generally to wireless communications systems and, in particular, to a system and method for updating software resident on a plurality of mobile devices.

Software programs installed on personal computers often require updating as new versions are released, bugs are fixed and data is updated. Common software updates include program data, such as virus definitions in an anti-virus program, patches and program fixes, and new feature enhancements. A new version of a software program may be available for purchase on a floppy or compact disk, allowing the user to manually install the update on the personal computer. Software updates may also be available for electronic delivery, such as from the software manufacturer's Internet website.

Some installed computer programs may be configured to periodically contact an Internet server associated with the software manufacturer at a known uniform resource locator (URL). Some sites require the user to identify the required software updates for downloading. Other sites require the personal computer to transmit configuration information about the personal computer, such as an operating system identifier, a version number of the software application and an identification of installed hardware. The Internet server will use that information to determine whether a new update is available for download. Identified software updates may be automatically downloaded or, alternatively, the installed computer program may be configured to prompt the user for approval before downloading. Suggested updates may be declined by a user, for example, due to memory limitations on the user's personal computer, the suggested updates being directed to data or features that are not relevant to the user or because the user lacks confidence in the integrity of the source of the suggested update.

Mobile devices, such as cellular telephones, personal digital assistants, and vehicle navigation systems, also include installed software for which updates may be available. Such software applications may be designed to interact with multiple types of mobile devices, each with its own software and firmware, unique hardware limitations and communications interfaces. Further, each mobile device may be specially configured by the mobile user, an enterprise management entity, a wireless carrier or other entity. Determining whether a new upgrade is appropriate for download to a particular mobile device often requires knowledge of the features and configurations of the mobile device. Because of privacy concerns, it is often desirable to protect the information stored on mobile devices and such information may not be available to a download server for use in recommending a suitable update.

Mobile users often fail to upgrade their installed software for a variety of reasons. A user may be reluctant to share its personal information with a third party to determine whether an appropriate update is available. A user may not trust the content received from a third party, may not know which updates it needs, or may simply find the task of upgrading software to be an inconvenience. While it is desirable to provide mobile users with the freedom to install third party software applications, a mobile carrier also has an interest in maintaining a certain user experience and quality of service, which may be affected by the mobile users' download activities.

### SUMMARY OF THE INVENTION

The present invention is a software update system and method for updating the software and data stored on a mobile device.

In one embodiment, a method for updating software resident on a mobile device is initiated by an update manager on the mobile device. The update manager prepares a request for update information in accordance with configuration information and security/privacy settings stored on the mobile device. The update manager collects local information in accordance with the configuration information and filters out collected local information in accordance with the security/privacy settings. The request is prepared with the remaining collected local information which may include identifiers for software and hardware resident on the mobile device. Due to security and privacy settings, the information in the request may be insufficient to identify the software resident on the mobile device.

The mobile device transmits the request to an update server and retrieves corresponding update information, which may include an identifier for each of a plurality of software updates that are available through the update server. The plurality of software may include software updates that are not compatible with the software installed on the mobile device. Based on the update information and the resident software, the mobile device selects at least one of the software updates, and downloads the selected software update from the identified download location. In one embodiment, the retrieved update information includes scheduling information corresponding to individual selected software updates, and downloading is performed in accordance with the scheduling information. The scheduling information may provide load balancing among a corresponding wireless network and the update server. The update information may also include a referral to another update server to which the update manager may direct another request for update information.

In an embodiment of the invention, all software updates for the mobile device are initiated through the update manager. In another embodiment, the update manager detects state information for the mobile device, and the software update process is performed only during periods in which the mobile device is in an idle state.

In a second embodiment of the present invention a system for providing software updates to a plurality of mobile devices includes a database and a server update manager. The database includes software program identifiers and identifiers for corresponding updates. The update manager includes a first procedure for selecting a subset of records from the update database in response to a request from a mobile device. The update information file, which includes the software program identifiers and update identifiers associated with the subset of records, is transmitted to the mobile device. A second procedure from the update manager downloads to the mobile device a software update in response to a request from the mobile device, the software update corresponding to an update identifier specified in the update information file.

In a third embodiment of the present invention, all updates for software resident on the mobile device are retrieved through the update manager. The update manager manages software updates for the mobile device, communicates with an update server to retrieve a listing of available software updates, and selects available software updates from the received list. The received list includes software updates that are not compatible with the mobile device. The update manager then selects available software updates, requests the selected updates from the update server and downloads and installs the selected updates. The mobile device further includes a memory storing configuration information, including an identification of the corresponding update server. In one embodiment, the update manager includes a scheduling function, for scheduling requests for selected updates in accordance with the update information.

A more complete understanding of the present invention will be afforded to those skilled in the art, as well as a realization of additional advantages and objects thereof, by a consideration of the following detailed description. Reference will be made to the appended sheets of drawings, which will first be described briefly.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates an embodiment of the present invention;

FIG. 2 illustrates an embodiment of a process performed by a mobile device for preparing a request for update information;

FIG. 3 illustrates an embodiment of an update information table;

FIG. 4 illustrates an embodiment of an update process performed by a mobile device; and

FIGS. 5-6 illustrate a second embodiment of the present invention.

### DETAILED DESCRIPTION OF THE DRAWINGS

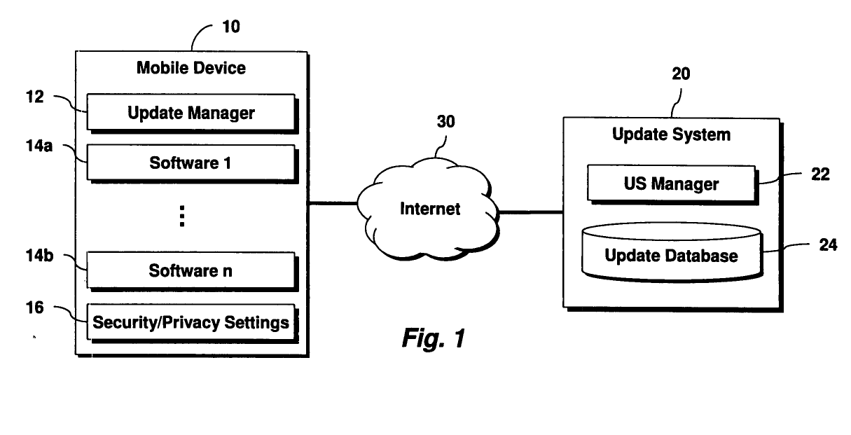

An embodiment of the present invention will now be described with reference to FIG. 1. A mobile device 10 is connected to an update system 20, which is adapted to facilitate software updates for the mobile device 10. In the exemplary embodiment, a communications link is established between the mobile device 10 and the update system 20 through the Internet 30. It will be appreciated that the mobile device 10 may be connected to the update system 20 through other communications links such as a wireless communications system, or a direct physical connection with a personal computer.

The mobile device 10 may be a mobile telephone, personal digital assistant, vehicle navigation system, portable computer or other device adapted for communications with the update system 20. It is contemplated that other devices, such as a stationary computer connected to the Internet, may also be adapted for communication with the update system 20. The mobile device 10 includes a mobile device update manager 12 and a plurality of software 14a-b that reside on the mobile device 10. The software 14 may include computer programs, components of computer programs, and data. The update system 20 is a server connected to the Internet 30 at a known Internet address, and includes an update system manager 22 and an update database 24. In the exemplary embodiment, the mobile device 10 is adapted to prohibit software updates that are not received through the update manager 12.

The mobile device update manager 12 is adapted to detect a connection with the Internet 30 and transmit requests to the update system 20 for software updates. The requests may be initiated manually by the mobile user, automatically (e.g., periodic, scheduled or event driven) by the update manager 12 or automatically by the update system 20. In one embodiment, the update manager 12 detects state information, including whether the mobile device is idle or in use, and whether the mobile device is roaming. In this embodiment, requests for updates may be initiated automatically when the mobile station is idle and operating on its own carrier network. The update manager 12 may also check state information during update requests, software downloading and other update functions, and pause the update process when the mobile device's state changes, such as when a mobile user initiates a mobile telephone call. The update process may continue after the mobile device becomes available. The request from the mobile device 10 may include personal information about the mobile device and mobile user including the date of prior software updates, the type and configuration of wireless device and an identification of the installed software.

In the exemplary embodiment, the mobile device 10 includes security/privacy settings 16 that are configurable by the mobile user, and the information transmitted to the update system 20 in the update request is filtered based on the selected security/privacy settings 16. At the highest levels, the security/privacy settings may prevent the mobile device 10 from transmitting any information regarding the mobile device 10 to the update system 20. At the lowest levels, the security/privacy settings may allow the mobile device 10 to freely transmit available information to the update system 20. It is anticipated that the security and privacy settings may be established by the mobile user, the mobile carrier, an enterprise manager entity or other entity.

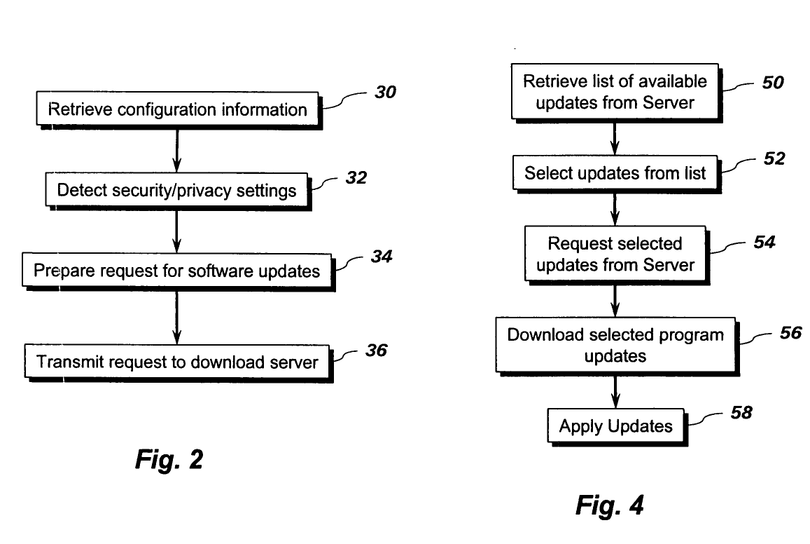

The update process will now be described with reference to FIGS. 1-4. In FIG. 2, a process performed by the mobile device 10 for preparing an update request is illustrated. In step 30, the mobile update manager 12 retrieves update configuration information stored locally on the mobile device 10. In the exemplary embodiment, the update configuration information includes the Internet address of the update system 20, a format for update requests and other information used by the mobile device 10 in preparing the update request including information identifying the mobile device (e.g., mobile telephone number), the type of firmware, installed software, current configuration and the dates of prior software updates.

In step 32, the mobile device detects the current security and privacy settings. The security and privacy settings may include device and operating systems settings for the mobile device (e.g., privacy settings on a web browser), as well as specific update process security and privacy settings configurable through the mobile device update manager 12. In step 34, the update manager 12 prepares the update request in accordance with the update configuration information and the security and privacy settings. In one embodiment, the update manager 12 retrieves the information specified in the update configuration information and prepares the request in the specified format, such as an XML message. Only information that meets the security and privacy levels will be included in the message, and other information will be filtered out. In step 36, the completed update request is transmitted to the download server at the predetermined address. In the exemplary embodiment of FIG. 1, the message is transmitted as an XML request through the Internet 30, and information that is missing or filtered out through the security/privacy filter is left blank or otherwise provided as a null value.

The update system manager 22 receives the transmitted update request from the mobile device 10, and prepares update information for download to the mobile device in accordance with the request. In the exemplary embodiment, the update system database 24 includes information updates that are available for a plurality of software applications, and that are available for installation onto a plurality of disparate mobile devices. Thus, the update system database 24 may include software updates that are not compatible with the mobile device 10.

The update system manager 22 uses the information received in the request to filter the update system database 24 to produce a set of update data in response to the update request. For example, if the update request provides no information regarding the mobile device 10, then the update information may include all available updates for all supported devices. The update request may identify the type of mobile device, in which case the update information may include only those updates that are compatible with the identified device. The update request may identify the resident software, in which case the update information may be limited to updates to the identified software. If the update request identifies the date of the last update, then the update information may include only updates that have become available since that date.

The update request from the mobile device 10 may identify software programs that are not identified in the update database 24. It is anticipated that the operator of the update system 20 will track such identified software and take steps to add corresponding updates to the update database 24.

In the exemplary embodiment, the update request specifies a format for the update information and a maximum size for the downloaded update information file. Where the update information file exceeds the maximum file size, the update system manager 22 separates the update information into a plurality of batch files. The first batch file may be transmitted to the mobile device 10 along with a batch identifier to be used by the mobile device in requesting subsequent batches. In an alternate embodiment, the update information file may be separated into batches if the size exceeds a predetermined size set by the update system 20.

The update server 20 may also include a statistics gathering function to collect personal information regarding the mobile device 10. The personal information may include information collected from update requests, information known about a mobile user (e.g., information from a mobile carrier's billing database), and a history of prior downloads. Additional statistics may track the percentage of users that are upgrading, the effectiveness of the update server, and download scheduling. Where available, this information may be used to help filter and prioritize future update requests for the mobile device.

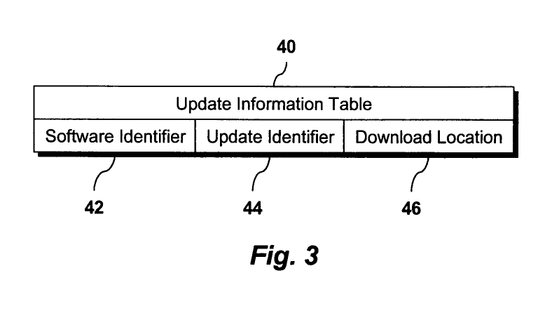

FIG. 3 provides a logical representation of update information 40, which includes one or more entries including a software identifier 42, an update identifier 44 and a download location 46. While the exemplary embodiment is illustrated as a text table, it should be appreciated that the update information may take other forms, such as an XML message. The software identifier 42 identifies a computer program for which an update is available, and is sufficient to allow the mobile device update manager 12 to match installed software 14 with its update identifier 44. The update identifier 44 identifies an individual update that is available for download and may include a version number and revision date. The download location 46 identifies the location through which the associated update may be acquired, and may include a URL. The update information table 40 may include additional information, such as a description of each update for use in a display prompt to the mobile user, a field identifying whether the update is optional or mandatory (e.g., updates that affect quality of service or security of mobile device), or a field specifying a scheduled time for downloading the identified update.

The update information may also include a referral to a third party server that includes the requested download. In this case, the downloaded information may include a referral URL. In a referral system, the update identifier 44 would not be included in the initial update information. The mobile device update manager 12 would use the referral URL as part of a separate update request to the third party server. In response, the mobile device 10 would receive update information on software updates that are available through the referral server. An update request to a referral system may operate in the same manner as an update request to the update server. In one embodiment, separate security and privacy settings may be applied to update requests sent to third party referral systems.

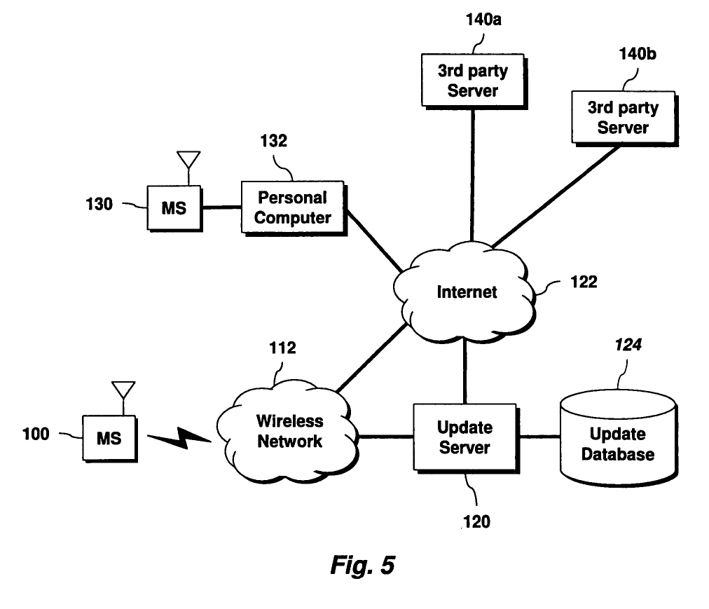

Referring to FIG. 4, an embodiment of the processing of the update information by the mobile device 10 will now be described. At step 50, the mobile device 10 receives a list of available updates from the update system 20 and at step 52, updates from the update information are selected. In one embodiment, the mobile device 10 steps through the update information to determine whether the associated software is resident on the mobile device and whether the associated update has been implemented on the mobile device. The mobile device may be configured to automatically implement all selected updates, automatically implement only required or recommended updates, or prompt the user for the user's approval before downloading the selected updates. The prompt may also include a notification that certain software loaded on the mobile station, or certain updates available for download, may affect the quality of service or operation of the mobile device. The prompt may also be used to provide the user with customized messages from the update server (e.g., “Thank you for using our product” or “Happy 4th of July!”). In one embodiment, the user is notified of identified updates through an alert or display icon in accordance with the features of the mobile device.

As part of the selection process, the mobile station checks available memory on the mobile device and prioritizes the selected updates to take advantage of the available memory. The selection process may also take into account personal information stored on the mobile device. For example, in a navigation system, an updated map from a geographic region not used by the mobile user may be optional, while an updated map of a current geographic region may have a higher priority. The update information may be deleted from the mobile device after the selection of updates to download.

In step 54, the mobile device 10 requests each of the selected updates from the update system 20. The request may list the update information entries that correspond to the requested updates. In one embodiment, the update system 20 gathers the requested updates into a single file for download to the mobile device 10. In an another embodiment, mobile device 10 sends separate requests, in the form of a URL, for each of the selected updates. In an alternate embodiment, the update server 20 provides update services for all of the software on the mobile device 10, including updates offered by third parties.

In step 56 the mobile device 10 downloads the selected software updates. In one embodiment, HTTP is used for delivering the update. If the download is interrupted before it is completed, the HTTP resume feature can be used to continue the download at a later time. When a partial download is found, the update manager will search at the next opportunity and resume the download. If the partial download is not compatible with the current version, then the partial download will be deleted and the new update will be downloaded in its entirety.

The selected software updates are applied in step 58. The updates may be applied using a variety of methods. In one approach, an installer program is downloaded. The installer is a self-executing program that installs the program update. A second approach is to deliver the entire program with the new update. A third approach is to deliver a differences patch, which only knows how to change a single version of the program to the new version of the program. A fourth approach is to download a patch that is capable of updating multiple versions of the program to the new version of the program. Under the third and fourth approaches, a patch application may reside on the mobile device as part of the mobile device update manager 12. The downloaded files may be validated by the mobile device update manager 12, such as by performing an authenticode check to verify the signature of what has been downloaded. After the program is updated, the update manager may delete the downloaded file.

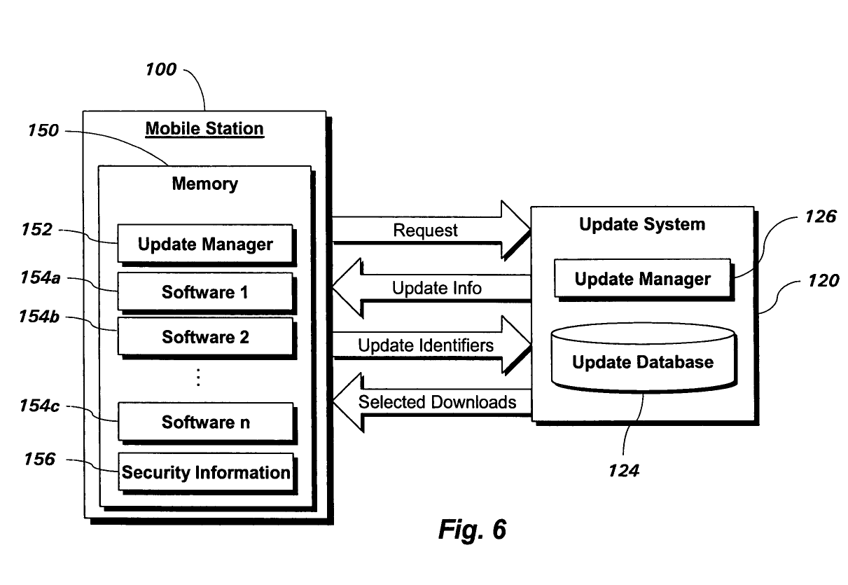

Another embodiment of the present invention will now be described with reference to FIG. 5. A mobile station 100 is adapted to communicate with a wireless communications network 112 using a wireless communications protocol such as CDMA. The mobile station 100 may include a mobile telephone, personal digital assistant, vehicle navigation systems, portable computer or any other wireless device adapted to communicate with the wireless network 112. The wireless communications network 112 is adapted to facilitate communications between the mobile station 100 and an update server 120. It will be appreciated that the wireless communications network 112 may be any communications network in which a mobile device is capable of communicating with a second device or entity across a wireless communications link and may include one or more of the following: terrestrial or satellite based cellular communications systems, personal communications systems, a specialized mobile radio system, an Advanced Mobile Phone systems, a GSM system, a CDMA system, a pager system, a walkie-talkie system and a packet data system.

The update server 120 may be operated by the mobile station's wireless carrier, a software manufacturer or third party service provider and is adapted to manage all updates of software and firmware resident on the mobile station 100. The update server 120 is connected to an update database 124 that includes information relating to the updates available to the mobile stations associated with the wireless communications system 112. The update server 120 may include one or more physical servers that may be geographically distributed across geographic regions.

Each mobile station is adapted to request all downloads through the update server 120, and in one embodiment, the mobile device is prohibited from downloading software or requesting updates through other sources. Directing downloads through the update server 120 has certain advantages including providing the carrier with control over the quality of service of the mobile device and reducing the mobile device's exposure to viruses. The update server 120 may be connected to the Internet 122, allowing a mobile station, such as mobile station 130, to communicate with the update server 120 through a personal computer 132 that is connected to the Internet 122. The update server 120 may also refer the mobile stations 100 & 130 to third party servers 140a-b for downloading certain updates.

The update server 120 may also include a load balancing function to manage software update traffic on the wireless communications network 112 and update server 120. In one embodiment, the update server receives traffic information from the wireless communications system and schedules update activities during the times where network traffic is expected to be low. The update server also tracks its workload and further schedules downloads to distribute the load on the update server. When the update server 120 transmits a plurality of available software updates to the mobile device, each identified software update may include a scheduled time for the mobile device to request the software update, if the update is selected for installation on the mobile device. The mobile device will include a program for receiving the update information and requesting the download at the specified time. In one embodiment, the user may override the automatic schedule feature and request downloads manually.

The operation of the update system of FIG. 5 will now be described with reference to FIG. 6. The mobile station 100 includes a memory 150 that stores an update manager 152 and a plurality of software and software related data 154a-c. The update process may be initiated by the mobile station 100 through the update manager 152, which periodically checks the update server 120 for new updates. In another embodiment, the update process may be delayed or scheduled by the update server 120. For example, the mobile station 100 may be configured to automatically check for available updates on a daily basis, while new updates may be available from the update server 120 on a monthly basis. To reduce the number of update requests received by the update server 120, the update server 120 may be configured to respond to an update request by transmitting a delay interval (e.g., 30 days) or date and time for a next scheduled update request. If the mobile station 100 is configured to check for a new update within the delay interval (or if the user manually requests updates within the period), the mobile station 100 may notify the user, without contacting the update server 120, that no new updates are expected until after the delay interval expires. It is contemplated that the user may override this feature and proceed with a manual update request if desired.

The update manager 152 first prepares a request for update information. In one embodiment, the update manager 152 accesses security and privacy information 156 stored in the memory 150. In this context, the security information 156 includes information on the types of information that may be shared across the network between the mobile station 100 and the update server 120. At the highest security level, no information concerning the mobile station 100 is shared with the update server through the request for update information. At lower security levels, the request may include information such as available memory, a listing of the software resident on the mobile station, the type of mobile station, and other information.

The request is then transmitted to the update server 120 which is controlled by an update manager 126. The update server 120 receives the request, and retrieves available updates from the update database 124 that respond to the request. If no information is provided with the request, the update information will include all currently available updates. The update information is then downloaded to the mobile station 100, where the update manager 152 scans the mobile station memory 150 for software and related files that match the update information. The update manager then transmits identifiers of the associated program updates to the update server 120. The update server 120 retrieves the update identifiers, gathers the associated updates and downloads the updates to the mobile station, which implements the updates. In another embodiment, the downloads may be delivered from the update server or through third party software providers. The update identifiers may include URLs that would allow the mobile station to download the updates directly from the third party servers via the Internet.

Having thus described various embodiments of the present invention, it should be apparent to those skilled in the art that certain advantages of the within described system have been achieved. It should also be appreciated that various modifications, adaptations, and alternative embodiments thereof may be made within the scope and spirit of the present invention.

What is claimed is:

1. A method for updating software resident on a mobile device comprising:
retrieving update information from a server, the update information including an identifier for each of a plurality of software updates;
selecting, based on the update information and the resident software, at least one of said software updates; and
downloading the selected software updates.

2. The method of claim 1 further comprising:
requesting the update information from the server, wherein all software updates available for the mobile device are initiated through the step of requesting.

3. The method of claim 2 further comprising:
preparing the request for update information in accordance with configuration information associated with the server and security/privacy settings on the mobile station.

4. The method of claim 3 wherein the step of preparing comprises:
collecting local information in accordance with the configuration information;
filtering out collected local information in accordance with the security/privacy settings; and
preparing the request with the remaining collected local information.

5. The method of claim 4 wherein the collected local information includes identifiers for software resident on the mobile station.

6. The method of claim 4 wherein the collected local information includes identifiers of resident mobile station hardware.

7. The method of claim 4 wherein the request is insufficient to identify the software resident on the mobile station.

8. The method of claim 4 wherein the request is insufficient to identify the mobile station hardware.

9. The method of claim 1 wherein the retrieved update information identifies software updates that are not compatible with the mobile device hardware.

10. The method of claim 1 wherein the retrieved update information identifies software updates that are not compatible with the installed software.

11. The method of claim 1 wherein the retrieved update information includes a referral to a referral server and wherein the mobile device retrieves additional update information from the referral server.

12. The method of claim 1 wherein the retrieved update information includes scheduling information corresponding to individual selected software updates, and wherein the step of downloading is performed in accordance with the scheduling information.

13. The method of claim 1 wherein the update information includes a first identifier for each software update and a second identifier for each associated software program.

14. The method of claim 1 wherein the step of selecting comprises:
scanning the mobile station for software associated with each first identifier.

15. The method of claim 1 further comprising detecting state information for the mobile device, and wherein the steps of retrieving, selecting and downloading are performed only during periods in which the mobile device is in an idle state.

16. A system for providing software updates to a plurality of mobile devices comprising:
a database of software program identifiers and identifiers for corresponding updates; and
an update manager software application including:
a first procedure adapted to select a subset of records from the database in response to a request from a mobile device, and transmit an update information file to the mobile device, the update information file including software program identifiers and update identifiers associated with the subset of records; and
a second procedure adapted to download to the mobile device a software update in response to a request from the mobile device, the software update corresponding to an update identifier specified in the update information file.

17. The system of claim 16 wherein at least one update identified in the update information file corresponds to a software application that is incompatible with the requesting mobile device.

18. The system of claim 16 wherein the update information file includes scheduling information corresponding to at least one of the identified updates.

19. The system of claim 18 wherein the scheduling information directs future download activities to balance the load on the update system.

20. The system of claim 16 wherein the request to produce an update information file includes data relating to the requester and wherein the update information file includes the database entries that are compatible with the data.

21. The system of claim 16 further comprising an input/output function for communicating with a wireless communications network, the input/output function receiving traffic information regarding the wireless communications network.

22. The system of claim 16 wherein the update information file includes at least one entry directed to a referral server, the referral server being the source of the identified software update.

23. A mobile device having at least one software application resident thereon comprising:
an update manager adapted to manage software updates for the mobile device, the update manager being adapted to perform steps including:
communicating with an update server to retrieve a listing of available software updates;
selecting available software updates from the received list, the received list including software updates that are not compatible with the mobile device;
requesting the selected updates from the update server; and
downloading and install the selected updates.

24. The mobile device of claim 23 further comprising a memory storing configuration information, including an identification of the corresponding update server.

25. The mobile device of claim 23 further comprising a scheduling function, wherein the requests for selected updates are scheduled in accordance with scheduling information received through the received listing of available software.

26. The mobile device of claim 23 wherein the update manager is further adapted to detect state information of the mobile device, and wherein the update manager performs update activities only when the mobile device is idle.

27. The mobile device of claim 23 wherein the step of communicating further comprises preparing a request for update information in accordance with configuration information associated with the server and security/privacy settings on the mobile station.

28. The mobile device of claim 27 wherein the step of preparing comprises:
collecting local information in accordance with the configuration information;
filtering out collected local information in accordance with the security/privacy settings; and
preparing the request with the remaining collected local information.

29. The mobile device of claim 23 wherein the retrieved listing of available software updates includes a referral to a referral server and wherein the mobile device retrieves additional update information from the referral server.
